(19) United States
(12) Patent Application Publication
(10) Pub. No.: US 2015/0294322 A1
(43) Pub. Date: Oct. 15, 2015

(54) SECURITY-MONITORING IMPLEMENTING CUSTOMER RECOGNITION VIA AN AUGMENTED REALITY DISPLAY

(71) Applicant: Bank of America Corporation, Charlotte, NC (US)

(72) Inventors: David M. Grigg, Rock Hill, SC (US); Richard Andrew Starbuck, Walnut Creek, CA (US); Carrie Anne Hanson, Charlotte, NC (US); Alicia C. Jones, Fort Mill, SC (US)

(73) Assignee: Bank of America Corporation, Charlotte, NC (US)

(21) Appl. No.: 14/250,972

(22) Filed: Apr. 11, 2014

(51) Int. Cl. G06Q 30/02; H04N 7/18; G06T 11/60; G06Q 10/06; G06K 9/00

(52) U.S. Cl. CPC G06Q 30/0201; G06Q 10/0635; G06K 9/00295; G06K 9/00778; G06T 11/60; H04N 7/183

(57) ABSTRACT

Systems, apparatus, and computer program products are provided for security-monitoring at a place of business by automatically determining which individuals within a business location, such as a retail store, banking center or the like, are established customers of the business. Such a determination of established customer status is conducted without requiring any action on behalf of the individuals/customers and may be accomplished proximate in time to the individuals arriving at the business location. Once the established customers have been determined, the present invention provides for attaching customer identifiers to the established customers appearing within a live video stream displayed by the security-monitoring system to thereby create an augmented reality environment within the display.

### FIELD

In general, embodiments of the invention relate to customer security-monitoring and, more particularly, to automatically determining which individuals within a live video stream of a business location are established customers of business and identifying the established customers within the live video stream displayed by a security-monitoring apparatus.

### BACKGROUND

Many businesses employ security-monitoring systems that monitor the activities conducted by customers within the business. Such security-monitoring systems implement one or more video cameras and a monitoring station at which a security guard or other user views a display of the live video stream captured by the video camera. The purpose of such security-monitoring systems is to identify individuals and/or situations that pose a threat to the business.

Currently, the security guard or user who is conducting the monitoring is limited as to the knowledge they possess about the customers that are being monitored. Specifically, the security guard is typically unaware of which of the customers are currently established customers of the business and, as such, may pose less of threat to the business than other customers that may not have an established relationship with the business.

Therefore, a need exists to develop systems, apparatus, methods, computer program products and the like that automatically, without requiring an action on behalf of customer/intervention, identify which individuals/customers within a business location are established customers of the business and, upon identification, present such information to a security-monitoring system. In this regard, the user of the security-monitoring system is provided awareness of established customer versus non-established customer status of the individuals/customers they are currently monitoring and can make further decisions on which individuals/customers to focus their intention on based on the established customer status.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, methods computer program products or the like for automatically determining which individuals within a business environment, such as a retail store, banking center or the like, are established customers (i.e., have conducted transactions with the business in the past and/or hold accounts at the business). Such a determination of established customer status is conducted without requiring any action on behalf of the individuals/customers currently located within the business environment and may be done nefariously without the knowledge of the individuals/customers currently located within the business environment. Once the established customers have been determined, the present invention provides for identifying the established customers within a live video stream displayed by a security-monitoring system. As a result of identifying established customers within the display of a security-monitoring system, the user of the security-monitoring system can make informed decisions on which individuals should be provided more focused attention in the overall security-monitoring process.

A system for monitoring security at a business location implementing customer recognition and identification of established customers within a business location, defines first embodiments of the invention. The system includes one or more security-monitoring apparatus having a memory, and a processor in communication with the memory. The security-monitoring apparatus additionally includes an image-capturing device, e.g., a video camera or the like, that is in communication with the processor, and a display in communication with the processor that is configured to display a live video stream captured by the image-capturing device. The system additionally includes a customer recognition and identification module that is stored in the memory and executable by the processor. The module is configured to receive, from the image-capturing device, the live video stream of the business location occupied by one of more individuals. In response to receiving the live video stream, the module is configured to determine which of the individuals within the live video stream are established customers of the business. Further, in response to determining the established customers, the module is configured to present, within the display, one or more customer identifiers within the live video stream. Each of each of the customer identifiers attaches to a corresponding established customer and follows the corresponding established customer as they move within the live video stream, thereby creating an augmented reality environment within the display.

In specific embodiments of the system, the customer recognition and identification module is further configured to determine which of the individuals within the live video stream are established customers by (1) capturing, by the wearable computing device, a facial image of one or more of the individuals, (2) determining one or more matches between the facial images of the individuals and facial images of established customers by comparing characteristics of the facial images of the individuals to a database of facial images of established customers, and (3) identifying one or more individuals within the view as established customers based on the one or more determined matches.

In other embodiments of the system, the customer recognition and identification module is further configured to determine which of the individuals within the live video stream are established customers by (1) receiving an electronic communication from mobile communication devices in possession of corresponding individuals displayed within the live video stream and (2) determining that the individual in possession of the mobile communication device is an established customer based on information in the electronic communication. The electronic communication is communicated from the mobile communication device (a) absent user input and (b) based on the mobile communication device being located within boundaries of the business location. In related embodiments of the system, the electronic communication is a token, stored at the Operating System (OS) level, which identifies the individual in possession of the mobile communication device as the established customer. In those embodiments in which the module is configured to determine established customers based on electronic communication from mobile communication devices in possession of individuals, the customer recognition and identification module may be further configured to determine the location of the mobile communication devices that have been determined to be in possession of the established customers, and present the customer identifiers, within the display of the security-monitoring apparatus, proximate to the location of the mobile communication devices.

In other specific embodiments of the system, the customer recognition and identification module is further configured to provide the user selectable access to display, on the display of the security-monitoring apparatus, of customer profile information associated with each of the established customer. In specific embodiments, the customer profile information includes risk-related data associated with the established customer, while in other embodiments the customer profile information including at least one of customer status, customer affinity, accounts held by the established customer at the business or products purchased at the business by the established customer.

A method for monitoring security at a business location implementing customer recognition and identification established customers within a business location, defines second embodiments of the invention. The method includes receiving, from an image-capturing device included in a security-monitoring apparatus, a live video stream of the business location occupied by one of more individuals. The method further includes determining which of the individuals within the live video stream are established customers of the business. In addition, the method includes presenting, within a display of the security-monitoring apparatus, one or more customer identifiers within the live video stream. Each of the customer identifiers attaches to a corresponding established customer and follows the corresponding established customer as they move within the live video stream, thereby creating an augmented reality environment within the display of the security-monitoring system.

In specific embodiments of the method, determining which of the individuals within the video stream are established customers further includes (1) capturing a facial image of one or more of the individuals from the live video stream, (2) determining one or more matches between the facial images of the individuals and facial images of established customers by comparing characteristics of the facial images of the individuals to a database of facial images of established customers, and (3) identifying one or more individuals within the view as established customers based on the one or more determined matches.

In other specific embodiments of the method, determining which of the individuals within the live video stream are established customers further includes (1) receiving an electronic communication from mobile communication devices in possession of corresponding individuals within the view and (2) determining that the individual in possession of the mobile communication device is an established customer based on information in the electronic communication. In such embodiments of the method, the electronic communication may be a token, which is stored at the OS-level, and identifies the individual in possession of the mobile communication device as the established customer and is communicated from the mobile communication device (a) absent user input and (b) based on the mobile communication device being located within boundaries of the business location. In related embodiments the method further includes determining the location of the mobile communication devices determined to be in possession of the established customers for the purpose of presenting, within the display of the security-monitoring apparatus, the one or more customer identifiers proximate to the location of the mobile communication devices.

In other specific embodiments the method includes providing selectable access to display, on the display of the security-monitoring apparatus, of customer profile information associated with each of the established customer. In such embodiments of the method, the customer profile information may include one or more of risk-related information associated with the established customer, customer status, customer affinity, accounts held by the established customer at the business or products purchased at the business by the established customer.

A computer program product including a non-transitory computer-readable medium defines third embodiments of the invention. The computer-readable medium includes a first set of codes for causing a computer to capture, by an image-capturing device included with a security-monitoring system, live video stream of a business location occupied by one of more individuals. The computer-readable medium additionally includes a second set of codes for causing a computer to determine which of the individuals displayed within the live video stream are established customers of a business. Moreover, the computer-readable medium includes a third set of codes for causing a computer to present, within a display of the security-monitoring apparatus, one or more customer identifiers within the live video stream. Each of the identifiers attaches to a corresponding established customer and follows the corresponding established customer as they move within the live video stream.

Thus, systems, apparatus, methods, and computer program products herein described in detail below provide for security-monitoring at a place of business by automatically determining which individuals within a business location, such as a retail store, banking center or the like, are established customers of the business. Such a determination of established customer status is conducted without requiring any action on behalf of the individuals/customers and may be accomplished proximate in time to the individuals arriving at the business location. Once the established customers have been determined, the present invention provides for attaching customer identifiers to the established customers appearing within a live video stream displayed by the security-monitoring system to thereby create an augmented reality environment within the display.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic view of a security monitoring system that is configured to identify individuals in the business location as established customers and present within the display of the security-monitoring system customer identifiers, in accordance with embodiments of the present invention;

FIG. 2 provides a block diagram of a security-monitoring system configured for identifying individuals in the business location as established customers and presenting, within the display of the security-monitoring system, customer identifiers, in accordance with embodiments of the present invention;

FIG. 3 provides a more detailed block diagram of a security-monitoring system configured for identifying individuals in the business location as established customers and presenting, within the display of the security-monitoring system, customer identifiers, in accordance with present embodiments of the invention; and

FIG. 4 provides a flow diagram of a method for security monitoring by identifying individuals in the business location as established customers and presenting, within the display of the security-monitoring system, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various security-monitoring systems, apparatus, methods for security-monitoring, and computer program products are herein described that automatically determining which individuals within a business environment, such as a retail store, banking center or the like, are established customers of the business. Such a determination of established customer status is conducted without requiring any action on behalf of the individuals/customers and may be done without the knowledge of the individuals/customers currently located within the business environment. Once the established customers have been determined, the present invention provides for identifying the established customers within a live video stream displayed by a security-monitoring system. As a result of identifying established customers within the display of a security-monitoring system, the user of the security-monitoring system can make informed decisions on which individuals should be provided more focused attention in the overall security-monitoring process

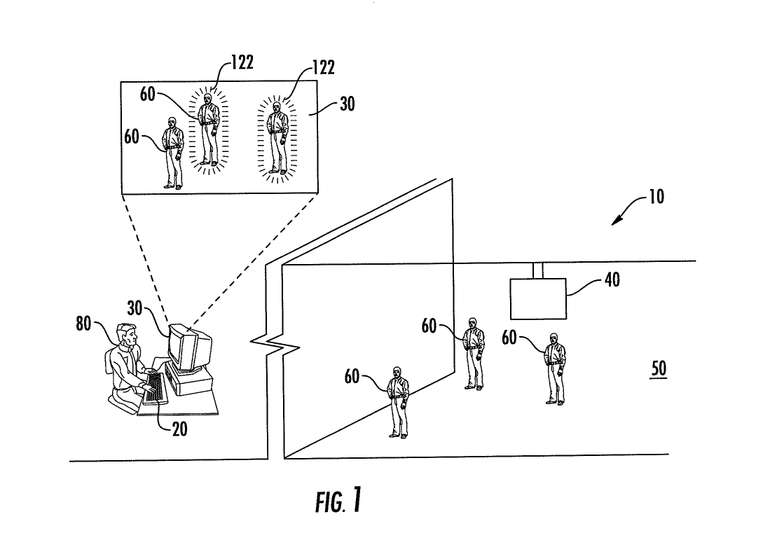

Referring to FIG. 1, a schematic diagram is presented of a security-monitoring system 10, in accordance with an embodiment of the present invention. The security-monitoring system includes a computing device 20 including a display 30. The computing device is in network communication with an image-capturing device 40, such as a ceiling-mounted security camera or the like. While the embodiment shown FIG. 1 is limited to a single image-capturing device 40 other embodiments of the invention may implement multiple image-capturing devices 40 for the purpose of ensuring proper monitoring of the environment. The image-capturing device 40 is located in a business location/environment 40, such as a retail store, a banking center or the like, which is occupied by one or more individuals 60. The individuals 60 may be new or potential customers of the business or the individuals may be established customers of the business (i.e., customers with a pre-existing relationship with the business, such as having conducted previous transactions with the business and/or having accounts with the business or the like).

In accordance with embodiments of the present invention, the computing device 20 of the security monitoring system 10 is configured to automatically (and without requiring action on the part of the individuals) identify which of the individuals being monitored are established customers. The means by which the individuals being monitored are identified as established customers are discussed in detail infra. In response to identification of the established customers, customer identifiers 122 are presented in the display 30 of computing device 20, such that user/security monitor 80 can readily comprehend which of the individuals being monitored are established customers. In the illustrated embodiment of FIG. 1 the customer identifier 122 is graphically presented as an outline around the established customer that serves to accentuate the established customer in the display. It should be noted that the customer identifier 122 make take on the form of any graphical indicator that differentiates the established customer from the other individuals within the display. In accordance with embodiment of the present invention, the graphical customer identifier 122 “attaches” to the established customer, such that as the established customer moves within the display (or moved into and/or out of the display) the customer identifier follows the established customer, thereby creating an augmented reality environment within the display 30. Further, the customer identifier 122 may be configured to include a user selectable link or the like, which when activated by the user/security monitor 80 provides the user/security monitor 80 access to customer profile information stored by the business.

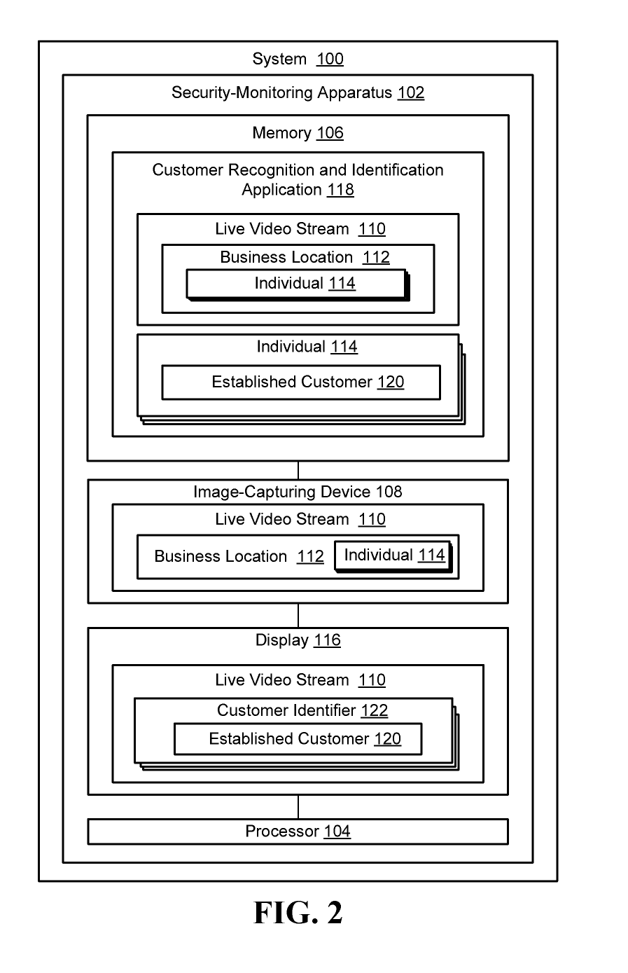

Referring to FIG. 2, a block diagram is presented of an system 100 configured for monitoring security at a business location implementing identification of established customers within augmented reality display, in accordance with embodiments of the present invention. The system includes a security-monitoring apparatus 102 implemented on a computing platform that includes a memory 106 and at least one processor 104 in communication with the memory 14. Additionally, security monitoring system 102 includes one or more image-capturing devices 108, such as security monitoring video camera or the like, that are in communication with processor 104 and are located, and strategically positioned, within a business so as to capture a live video stream 110 of the business location(s) 112 within the business occupied by individuals 114 (i.e., non-employees, such as new/potential customers and/or existing/established customers). In addition, security monitoring apparatus 102 includes display 116 that is in communication with the processor 104 and configured to display the live video stream 110 of the business location 112 as captured by image-capturing device 108.

The memory 106 of security-monitoring apparatus 102 stores customer recognition and identification application 118 that is configured to receive the live video stream 110 of the business location(s) 112 that are occupied by one or more individuals 114 and automatically identify/determine (without requiring any overt action by the individuals) which of the individuals 114 being monitored by the security-monitoring apparatus 102 (i.e., which of the individuals 120 in the live video stream 110) are established customers 120 of the business. In response to the identification/determination of established, the customer recognition and identification application 112 is further configured to present customer identifiers 122 in the live video stream 110 of display 116, which serve to identify those individuals that have been identified as established customers 120. The customer identifiers 122 are presented in the display 116 so to “attach” to a corresponding established customer 120. Attachment provides for the customer identifier 122 to follow the corresponding established customer 120 as the established customer moves within (and into and out of) the live video stream 110 displayed on display 116. In this regard, the attached customer identifier 122 provides for augmented reality environment within the live video stream whereby individuals identified as established customers are continuously identified with the display as such, thus allowing the security monitor viewing the display 116 to be constantly aware of which individuals are established customers 120 and conversely, which of the individuals are not established customers.

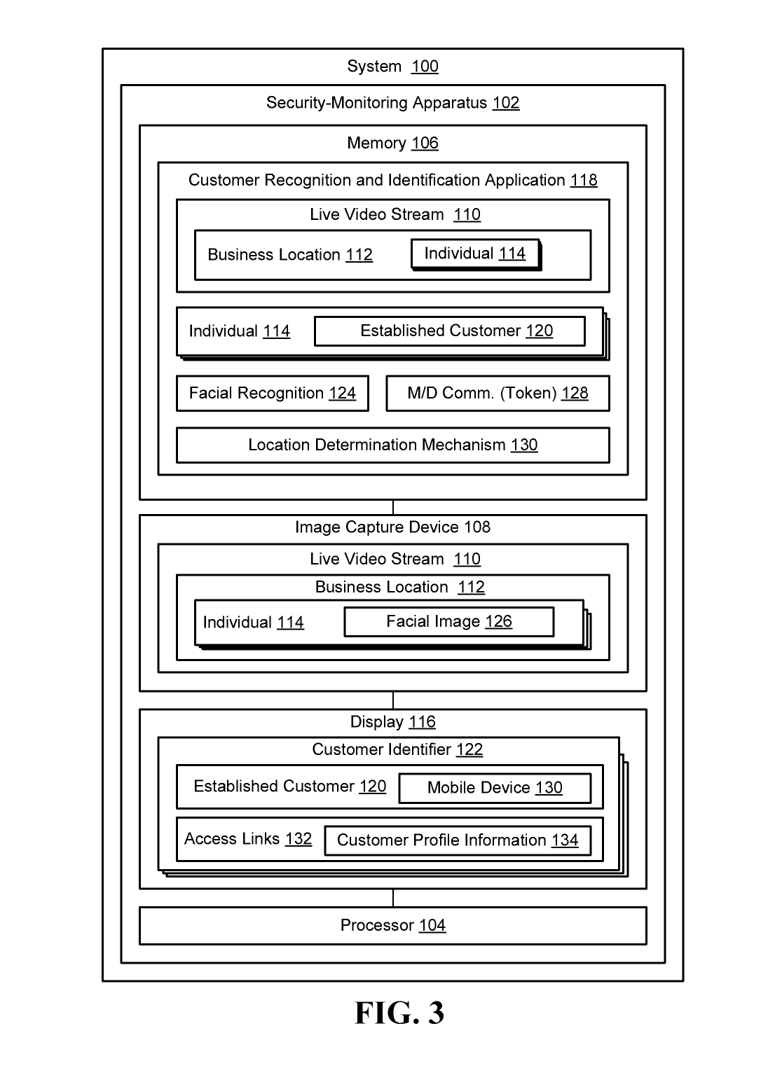

Referring to FIG. 3, a block diagram is presented of a system 100 configured for monitoring security at a business location implementing identification of established customers within augmented reality display, in accordance with embodiments of the present invention. The system 100 includes security-monitoring apparatus 102 which may include any type and/or combination of one or more computing devices. The apparatus 102 is operable to receive and execute modules, routines and applications, such as customer recognition and identification application 118 and the like.

The apparatus 102 includes a computing platform that can receive and execute routines and applications. The computing platform includes memory 106, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, the computing platform also includes at least one processor 104, which may be an application-specific integrated circuit (“ASIC”), or other chipset, processor, logic circuit, or other data processing device. Processor 104 or other processor such as ASIC may execute an application programming interface (“API”) layer (not shown in FIG. 3) that interfaces with any resident programs, such as customer recognition and identification application 118 or the like, stored in the memory 106 of apparatus 102. Processor 104 includes various processing subsystems (not shown in FIG. 3) embodied in hardware, firmware, software, and combinations thereof, that enable the functionality of apparatus 102 and the operability of the apparatus on a network. For example, processing subsystems allow for initiating and maintaining communications, and exchanging data, with other networked devices. Additionally, processing subsystems may include any portion of the functionality of customer recognition and identification application 118 obviating the need for such applications and modules to be stored in the memory.

As previously noted in relation to FIG. 2, security monitoring apparatus 102 includes one or more image-capturing devices 108, such as security monitoring video camera or the like, that are in communication with processor 104 and are located, and strategically positioned, within a business so as to capture a live video stream 110 of the business location(s) 112 within the business occupied by individuals 114 (i.e., non-employees, such as new/potential customers and/or existing/established customers). In addition, security monitoring apparatus 102 includes display 116 that is in communication with the processor 104 and configured to display the live video stream 110 of the business location 112 as captured by image-capturing device 108.

The memory 106 of security-monitoring apparatus 102 stores customer recognition and identification application 118 that is configured to receive the live video stream 110 of the business location(s) 112 that are occupied by one or more individuals 114 and automatically identify/determine (without requiring any overt action by the individuals) which of the individuals 114 being monitored by the security-monitoring apparatus 102 (i.e., which of the individuals 120 in the live video stream 110) are established customers 120 of the business.

In specific embodiments of the invention, the customer recognition and identification application 118 is configured to implement facial recognition 124 processing to identify which of the individuals 114 within the live video stream 110 are established customers 120. In such embodiments of the invention, the application 118 is configured to capture facial images 126 of the individuals 114 from the live video stream 110. In response to capturing the facial images 126, the application 118 is further configured to access a database (not shown in FIG. 3, such as a customer profile database that includes stored facial images of established customers, compare characteristics of the facial images 126 of the individuals 114 to the facial images of established customers and determine one or matches between the facial images 126 of the individuals 114 and the facial images of established customers. A “match” results from a predetermined percentage of certainty that an individual in one image is the same individual in another image based on predetermined level of similar or same characteristics within the images (e.g., facial structure, eye geometry, eye color, nose geometry/shape, and the like). Established customer(s) 120 are identified based on a determined match between the captured facial image 126 and a facial image stored in the database.

In other embodiments of the invention, the customer recognition and identification application 118 is configured to determine which of the individuals 114 within the live video stream 110 are established customers based on the application receiving an electronic communication 128 from a mobile communication device (not shown in FIG. 3) in possession of a corresponding individual 114 displayed in the live video stream 110. The electronic communication is communicated from the mobile communication device automatically without any overt action being taken by the individual in possession of the device and is communicated based on the mobile communication device being located within predetermined boundaries of the business location (i.e., “onsite” at the business location). In specific embodiments of invention, the electronic communication 128, itself, may identify the possessor of the mobile communication device as an established customer 120. For example, the electronic communication 128 may comprise an electronic token, such as an electronic credit/debit card, that is issued or otherwise assigned by the business. The electronic token is stored at Operating System (OS)-level within the mobile communication device and, as such, does not require the user to launch or have an application running in order to communicate the token. The electronic communication 128, in the form of a token or the like, may be broadcasted continuously or periodically from the mobile communication device, such as via wireless, cellular or short range wireless communication or the like, or in other embodiments of the invention the electronic communication 128 may be communicated to the application 118 in response to receiving a request from the application or from the business (i.e., another application). In such embodiments of the invention, the mobile communication device may be configured to receive the request based on the mobile communication device storing an business-related application, for example a mobile banking application associated with a financial institution/bank, a customer loyalty application associated with a store or the like. It should be noted that application does not be launched/running for the mobile communication device to receive the request, the mere presence of the application on the mobile communication device will allow for the device to receive the request. In other related embodiments of the invention, the electronic communication 128, itself, does not identify the possessor of the mobile communication device as an established customer but rather includes information about the individual that possesses the mobile communication device. In which case, a customer database may be accessed and the information included in the electronic communication is compared to customer information to determine if the individual that possesses the mobile communication device is an established customer 120 of the business.

In such embodiments of the invention in which receipt of an electronic communication in possession of an individual 114 is used to identify the individual as an established customer 120. The customer recognition and identification application 118 may further be configured to implement location determining mechanism 130 to determine the location of the mobile communication device within the business location 122. The location determining mechanism may include triangulation, Global Positioning System (GPS) or the like. The location of the mobile communication device may be necessary in order to present the customer identifier 122 in the display 116 proximate to the location of the mobile communication device (i.e., proximate to the location of the established customer 120 that is in possession of the mobile communication device).

In response to the identification/determination of established, the customer recognition and identification application 112 is further configured to present customer identifiers 122 in the live video stream 110 of display 116, which serve to identify those individuals that have been identified as established customers 120. The customer identifiers 122 are presented in the display 116 so to “attach” to a corresponding established customer 120. Attachment provides for the customer identifier 122 to follow the corresponding established customer 120 as the established customer moves within (and into and out of) the live video stream 110 displayed on display 116. In this regard, the attached customer identifier 122 provides for augmented reality environment within the live video stream whereby individuals identified as established customers are continuously identified with the display as such, thus allowing the security monitor viewing the display 116 to be constantly aware of which individuals are established customers 120 and conversely, which of the individuals are not established customers. In alternative embodiments of the invention, in which the established customer 120 is determined based on receipt of electronic communication 128 from a mobile communication device in possession of the established customer 120, the customer identifier 122 may attach to the mobile communication device 130.

As discussed briefly in relation to FIG. 1, the customer identifier 122 may additionally include embedded access links 132, which allow the security/monitor/user to activate the links to access and display the customer profile information 132. The customer profile information may include, but is not limited to, risk-related information, customer status information (e.g., VIP/high volume account holder status or the like), customer affinity information, previous transactions with the business, accounts held by the customer at the business and the like. Risk-related information may include the customer's current risk score or assessment that takes into account various factors such as the type of transactions conducted by the customer, the location of the transactions, the amount of the transactions, the counterparty to the transactions and the like. In addition, customer profile information that is accessed and displayed may include a facial image of the customer, which allows for the security monitor/user to visually confirm the established customer identification/determination.

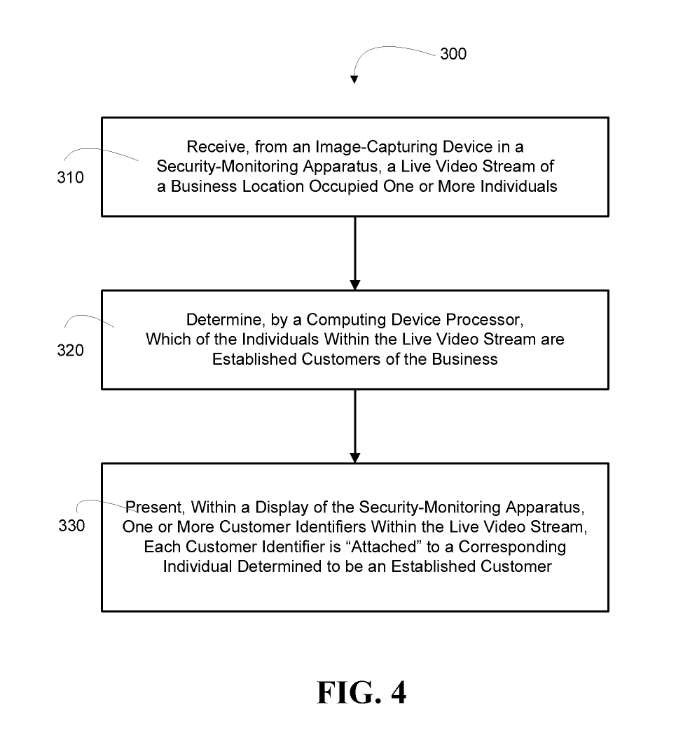

Referring to FIG. 4, a flow diagram is presented of a method 300 for security monitoring at a business location implementing identification of established customers within augmented reality display, in accordance with embodiments of the present invention. At Event 310, a live video stream that has been captured by an image-capturing device in a security-monitoring apparatus is received. The live video stream is of a business location, e.g., retail store, banking center or the like, that is occupied by one or more individuals. The individuals are non-employees and may be new or potential customers or pre-existing/established customers of the business.

At Event 320, a determination is made as to which of the individuals in the live video stream are established customers of the business. In specific embodiments of the invention, the determination of established customers includes capturing, from the live video stream, facial images of the individuals and accessing a customer database that stores facial images of customers to compare characteristics of the facial images of the individuals in the live video stream to characteristics of the stored facial images of customers. Based on determining matches between the facial images of the individuals in the live video stream to the stored facial images of customers, individuals within the live video stream are identified as being established customers of the business.

In other embodiments of the invention, established customers are determined based on receipt of an electronic communication from a mobile communication device in possession of a corresponding individual displayed in the live video stream. The electronic communication is communicated from the mobile communication device automatically without any overt action being taken by the individual in possession of the device and is communicated based on the mobile communication device being located within predetermined boundaries of the business location (i.e., “onsite” at the business location). In specific embodiments of invention, the electronic communication, itself, may identify the possessor of the mobile communication device as an established customer. For example, the electronic communication may comprise an electronic token, such as an electronic credit/debit card, that is issued or otherwise assigned by the business. The electronic token is stored at Operating System (OS)-level within the mobile communication device and, as such, does not require the user to launch or have an application running in order to communicate the token. The electronic communication, in the form of a token or the like, may be broadcasted continuously or periodically from the mobile communication device, such as via wireless, cellular or short range wireless communication or the like, or in other embodiments of the invention the electronic communication may be communicated to the application in response to receiving a request from the application or from the business (i.e., another application). In such embodiments of the invention, the mobile communication device may be configured to receive the request based on the mobile communication device storing an business-related application, for example a mobile banking application associated with a financial institution/bank, a customer loyalty application associated with a store or the like. It should be noted that application does not be launched/running for the mobile communication device to receive the request, the mere presence of the application on the mobile communication device will allow for the device to receive the request. In other related embodiments of the invention, the electronic communication, itself, does not identify the possessor of the mobile communication device as an established customer but rather includes information about the individual that possesses the mobile communication device. In which case, a customer database may be accessed and the information included in the electronic communication is compared to customer information to determine if the individual that possesses the mobile communication device is an established customer of the business.

At Event 330, one or more customer identifiers are presented within the live video stream displayed within a display of the security-monitoring apparatus. Each of the customer identifiers corresponds to an individual in the live video stream that has been determined to be an established customer. The customer identifier may be any graphical display that visually conveys to the user/security monitor that the individual is an established customer, the identifier may serve to outline, make brighter, superimpose or the like the individual that has been determined to be an established customer. The customer identifiers “attach” to the corresponding individual/established customer, such that as the individual/established customer moves about within the live video stream displayed, the customer identifier follows the individual/established customer, thereby creating an augmented reality environment within the display. Further, the customer identifier 122 may be configured to include a user selectable link or the like, which when activated by the user/security monitor 80 provides the user/security monitor 80 access to customer profile information stored by the business. Customer profile information may include, but is not limited to, a photograph of the customer, risk-related information, customer status, customer affinities, transaction conducted by the customer at the business, accounts held by the customer at the business and the like.

The following United States Patent applications, which have been filed concurrently with the present application, are assigned to the same inventive entity as the present invention and include common inventors, are herein incorporated by reference as if set forth fully herein:

| | U.S. patent application | | |
|---|---|---|---|
| Docket Number | Ser. No. | Title | Filed On |
| 6131US1.014033.2196 | | USER | Apr. 11, 2014 |
| | | AUTHENTICATION | |
| | | BY OPERATING | |
| | | SYSTEM-LEVEL | |
| | | TOKEN | |
| 6133US1.014033.2193 | | USER | Apr. 11, 2014 |
| | | AUTHENTICATION | |
| | | BY TOKEN AND | |
| | | COMPARISON TO | |
| | | VISITATION PATTERN | |
| 6134US1.014033.2191 | | CUSTOMER | Apr. 11, 2014 |
| | | RECOGNITION | |
| | | THROUGH USE OF AN | |
| | | OPTICAL HEAD- | |
| | | MOUNTED DISPLAY | |
| | | IN A WEARABLE | |
| | | COMPUTING DEVICE | |

Thus, systems, apparatus, methods, and computer program products described above provide for security-monitoring at a place of business by automatically determining which individuals within a business location, such as a retail store, banking center or the like, are established customers of the business. Such a determination of established customer status is conducted without requiring any action on behalf of the individuals/customers and may be done without the knowledge of the individuals/customers currently located within the business environment. Once the established customers have been determined, the present invention provides for attaching customer identifiers to the established customers appearing within a live video stream displayed by the security-monitoring system to thereby create an augmented reality environment within the display.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for monitoring security at a business location implementing customer recognition and identification of established customers within a business location, the apparatus comprising:
one or more security-monitoring apparatus including a memory, a processor in communication with the memory, an image-capturing device in communication with the processor and a display in communication with the processor and configured to display a live video stream captured by the image-capturing device; and
a customer recognition and identification module stored in the memory, executable by the processor and configured to:
receive, from the image-capturing device, the live video stream of the business location occupied by one of more individuals
determine which of the individuals within the live video stream are established customers of the business, and
present, within the display, one or more customer identifiers within the live video stream, wherein each of the identifiers attaches to a corresponding established customer and follows the corresponding established customer as they move within the live video stream.

2. The system of claim 1, wherein the customer recognition and identification module is further configured to determine which of the individuals within the live video stream are established customers by:
capturing, by the image-capturing device, a facial image of the individuals;
determining one or more matches between the facial images of the individuals and facial images of established customers by comparing characteristics of the facial images of the individuals to a database of facial images of established customers; and
identifying one or more individuals within the view as established customers based on the one or more determined matches.

3. The system of claim 1, wherein the customer recognition and identification module is further configured to determine which of the individuals within the live video stream are established customers by:
receiving an electronic communication from mobile communication devices in possession of corresponding individuals displayed within the live video stream, wherein the electronic communication is communicated from the mobile communication device (1) absent user input and (2) based on the mobile communication device being located within boundaries of the business location; and
determining that the individual in possession of the mobile communication device is an established customer based on information in the electronic communication.

4. The system of claim 3, wherein the customer recognition and identification module is further configured to determine which of the individuals within the live video stream are established customers by receiving the electronic communication, wherein the electronic communication is a token that identifies the individual in possession of the mobile communication device as the established customer.

5. The system of claim 3, wherein the customer recognition and identification module is further configured to determine the location of the mobile communication devices that have been determined to be in possession of the established customers, and wherein the customer identifiers are presented, within the display of the security-monitoring apparatus, proximate to the location of the mobile communication devices.

6. The system of claim 1, wherein the customer recognition and identification module is further configured to provide the user selectable access to display, on the display of the security-monitoring apparatus, of customer profile information associated with each of the established customer.

7. The system of claim 6, wherein the customer recognition and identification module is further configured to provide the user selectable access to display, on the display of the security-monitoring apparatus, of the customer profile information, wherein the customer profile information includes risk-related data associated with the established customer.

8. The system of claim 6, wherein the customer recognition and identification module is further configured to provide the user selectable access to display, on the display of the security-monitoring apparatus, of the customer profile information including at least one of customer status, customer affinity, accounts held by the established customer at the business or products purchased at the business by the established customer.

9. A method for monitoring security at a business location implementing customer recognition and identification established customers within a business location, the method comprising:
receiving, from an image-capturing device included in a security-monitoring apparatus, a live video stream of the business location occupied by one of more individuals;
determining, by a computing device processor, which of the individuals within the live video stream are established customers of the business; and
presenting, within a display of the security-monitoring apparatus, one or more customer identifiers within the live video stream, wherein each of the identifiers attaches to a corresponding established customer and follows the corresponding established customer as they move within the live video stream.

10. The method of claim 9, wherein determining which of the individuals within the video stream are established customers further comprises:
capturing, by a computing device processor, a facial image of one or more of the individuals from the live video stream;
determining, by a computing device, one or more matches between the facial images of the individuals and facial images of established customers by comparing characteristics of the facial images of the individuals to a database of facial images of established customers; and
identifying, by a computing device, one or more individuals within the view as established customers based on the one or more determined matches.

11. The method of claim 9, wherein determining which of the individuals within the live video stream are established customers further comprises:
receiving, by a computing device processor, an electronic communication from mobile communication devices in possession of corresponding individuals within the view, wherein the electronic communication is a token that identifies the individual in possession of the mobile communication device as the established customer and is communicated from the mobile communication device (1) absent user input and (2) based on the mobile communication device being located within boundaries of the business location; and
determining, by a computing device processor, that the individual in possession of the mobile communication device is an established customer based on information in the electronic communication.

12. The method of claim 11, further comprising determining, by a computing device processor, the location of the mobile communication devices determined to be in possession of the established customers and wherein presenting, within the display of the security-monitoring apparatus, the one or more customer identifiers further comprises presenting, within the display of the security-monitoring apparatus, the one or more customer identifiers proximate to the location of the mobile communication devices.

13. The method of claim 9, further comprising providing, by a computing device processor, selectable access to display, on the display of the security-monitoring apparatus, of customer profile information associated with each of the established customer, wherein the customer profile information includes risk-related information.

14. The method of claim 9, further comprising providing, by a computing device processor, selectable access to display, on the OHMD, of customer profile information associated with each of the established customer, wherein the customer profile information includes at least one of customer status, customer affinity, accounts held by the established customer at the business or products purchased at the business by the established customer.

15. A computer program product comprising:
a non-transitory computer-readable medium comprising:
a first set of codes for causing a computer to capture, by an image-capturing device included with a security-monitoring system, live video stream of a business location occupied by one of more individuals;
a second set of codes for causing a computer to determine which of the individuals displayed within the live video stream are established customers of a business; and
a third set of codes for causing a computer to present, within a display of the security-monitoring apparatus, one or more customer identifiers within the live video stream, wherein each of the identifiers attaches to a corresponding established customer and follows the corresponding established customer as they move within the live video stream.

16. The computer program product of claim 15, wherein the second set of codes is further configured to cause the computer to (1) capture a facial image of one or more of the individuals in the live video stream, (2) determine one or more matches between the facial images of the individuals and facial images of established customers by comparing characteristics of the facial images of the individuals to a database of facial images of established customers, and (3) identify one or more individuals within the live video stream as established customers based on the one or more determined matches.

17. The computer program product of claim 15, wherein the second set of codes is further configured to cause the computer to (1) receive an electronic communication from mobile communication devices in possession of corresponding individuals within the live video stream, wherein the electronic communication is a token that identifies the individual in possession of the mobile communication device as the established customer and is communicated from the mobile communication device absent user input and based on the mobile communication device being located within boundaries of the business location, and (2) determine that the individual in possession of the mobile communication device is an established customer based on information in the electronic communication.

18. The computer program product of claim 17, further comprising a fourth set of codes for causing a computer to determine the location of the mobile communication devices determined to be in possession of the established customers and the third set of codes is further configured to cause the computer to present, within the display of the security-monitoring apparatus, the one or more customer identifiers proximate to the location of the mobile communication devices.

19. The computer program product of claim 15, wherein the third set of codes is further configured to cause the computer to provide selectable access to display, on the display of the security-monitoring apparatus, of customer profile information associated with each of the established customers, wherein the customer profile information includes risk-related information associated with the established customer.

20. The computer program product of claim 15, wherein the third set of codes is further configured to cause the computer to provide selectable access to display, on the display of the security-monitoring apparatus, of customer profile information associated with each of the established customers, wherein the customer profile information includes at least one of customer status, customer affinity, accounts held by the established customer at the business or products purchased at the business by the established customer.
